(19) United States
(12) Patent Application Publication
(10) Pub. No.: US 2014/0154476 A1
(43) Pub. Date: Jun. 5, 2014

(54) Heating Article Comprising a Microstructured Heat-Stable Coating and Method of Manufacturing Such an Article

(71) Applicants: Jean-Luc Perillon, Saint Paul Trois Chateaux (FR); Stephanie Le Bris, Chambery (FR)

(72) Inventors: Jean-Luc Perillon, Saint Paul Trois Chateaux (FR); Stephanie Le Bris, Chambery (FR)

(73) Assignee: SEB S.A., Ecully (FR)

(21) Appl. No.: 14/234,221

(22) PCT Filed: Jul. 25, 2012
(86) PCT No.: PCT/FR2012/051767

§ 371 Date: Jan. 22, 2014

(30) Foreign Application Priority Data
Jul. 25, 2011 (FR) 1156733

(51) Int. Cl. A47J 36/02; B41M 3/00

(52) U.S. Cl. CPC A47J 36/025; B41M 3/00
USPC 428/172; 427/256

(57) ABSTRACT

Provided is a heating article comprising a substrate having two opposite surfaces, a heat-stable coating comprising at least one base layer comprising at least one heat-stable binder, said base layer being arranged on one of the surfaces of the substrate, and one microstructured surface layer comprising a heat-stable binder of the same chemical nature as that of the base layer. The microstructured layer partly or fully covers the base layer and is sintered integrally to it. The microstructured surface layer has a relief with patterns comprised of local variations in its surface level, said relief having a regularity in average pitch Ar with a variation SAr which is not more than 10% higher or lower than the value of said average pitch Ar. A method of manufacturing such an article is also provided.

The present invention generally relates to articles coated with a heat-stable coating, and more particularly heating articles comprising a heat-stable coating having a surface microstructuring. The present invention also relates to a method of manufacturing such articles.

The articles covered by the present invention may particularly be culinary articles such as pans, pots, or skillets, barbecue grills, soles, irons, or hair straightening plates.

Within the meaning of the present invention, heating article refers to an article which has its own heating system, or which is heated by an external system and which is capable of transmitting the heat energy provided by this system to a material or third object in contact with said article.

Within the meaning of the present invention, surface microstructuring refers to a surface layer of micrometric roughness.

Within the meaning of the present invention, micrometric roughness refers to a relief having patterns composed of local variations at the surface of the surface layer in the micron range.

For the user of a culinary article, it is particularly interesting that during cooking, food sticks as little as possible, and thus, without using additional fats, and also the cleaning of the utilized article is as easy and as fast as possible.

At present, the coatings of heating culinary articles, such as the fluoropolymer-based (particularly PTFE-based) or ceramic-based (particularly obtained by sol-gel process) ones, are intrinsically non-sticking and hydrophobic whereby their chemical nature, as taught particularly in French Patents FR 2904206 and FR 2915205. The static contact angle Θ between these coatings and water is in the range of 115° at room temperature and decreases when the temperature of the coatings increases, which means that at food cooking temperature, a low static contact angle value is reached, in the range of 60°,which is unacceptable.

Hence, it is clear that there is an interest in developing coatings which are hydrophobic at both room temperature and higher temperatures, and particularly at the operating temperatures of these heating articles (for example, at the cooking temperature in the case of a culinary article).

Furthermore, it is known that the physical properties (such as roughness) also confer hydrophobic and self-cleaning properties to a given surface. Therefore, it can be observed in nature and more particularly on lotus leaves, a super-hydrophobicity phenomenon (also called “lotus effect”) related to the micrometric roughness of these leaves: this phenomenon is characterized by a static contact angle that can reach up to 160°.

It is particularly difficult to obtain such structures, and even impossible to carry out on non-stick coatings using the traditional coating techniques (spray, roller, curtain, screen printing) for which a leveling effect is sought (i.e. as smooth as possible). Consequently, even when the substrate surface on which the coating is deposited is structured, it is impossible to maintain a truly superhydrophobic surface at the surface of the latter.

Several types of techniques are known for microstructuring the surface of an article.

It is possible, for example, to include into the coating composition an immiscible substance that is sufficiently dispersed in the coating composition, and which then must be removed by thermal or chemical treatment. However, such a technique has the disadvantage of being difficult to generalize and perform in industry. In fact, the quality control of the dispersion in liquid form, and then in the different phases of manufacture (drying, curing, and possibly post-treatment) and the post-treatment itself (for example, by selective dissolution of a filler such as calcium carbonate) generate additional costs incurred by the need for additional staff, protective masking, washing and rinsing to ensure that the coating is at a food-grade level (i.e. may be in contact with food). Furthermore, these operations generate effluents which also must be treated.

Another solution is taught by German Patent DE 4434425 describing the production of non-stick coatings on the surface of a substrate made of soft metal, such as aluminum, especially for pot coatings. The manufacturing method of DE 4434425 includes a step of roughening the substrate surface, then a step of coating this rough surface with one or several layers of hard material, for example with hard-anodized coating layers, and then with one or several fluorocarbon resin-based non-stick layers of material such as polytetrafluoroethylene (PTFE), TFE-hexafluoropropylene copolymer (FEP) or TFE-ethylene copolymer (ETFE). The surface roughness may be particularly obtained by thermal spraying or conversion treatment. However, these techniques only allow partial control of average parameters defining the obtained surface roughness, consequently the latter not being locally controlled. Thus, the non-stickiness of the obtained coating is, not only totally unsatisfactory, but also not entirely constant over the entire surface of said coating. Particularly, as it is difficult to ensure a homogenous distribution, it is easily obtained a wide distribution of roughness that generates important variations of contact angles.

Another solution is taught by U.S. Patent Application 2005/170098 that describes a substrate particularly in glass, ceramic or metal, having at least one self-cleaning surface including a coating layer having a micro-rough surface structure that is at least partially hydrophobic. This micro-rough layer is obtained by applying a mixture containing a glass frit and structuring particles having an average diameter of the order of 1.1 to 50 μm, and preferably between 0.2 and 20 μm. The application of the micro-rough layer is followed by a conventional curing that leads to the fusion of the glass frit. This microstructuring technique allows only for a partial control of average parameters defining the obtained surface microroughness, which is consequently not being locally controlled.

Another solution is still taught by the European Patent Application EP 2308607, describing a multi-layered non-stick coating containing a first microstructured layer on which a second sub-microstructured layer in the form of fluorocarbon resin (for example PTFE, PFA and FEP) particles is placed which may particularly have a diameter ranging between 50 and 300 nm. The first layer may contain mineral particles, such as the SiC or PPSO₂ or even alumina particles, and the second layer may contain, in addition to the dispersed fluorinated particles, whiskers (particularly potassium titanate based). The two layers of the non-stick coating are deposited by flame spraying. They can be formed on a surface of the substrate that has been macrostructured beforehand particularly by sandblasting. Hence, EP 2308607 makes known a double-structured (or even triple-structured if the support is sanded) non-stick coating, whereof the roughness of the surface layers advantageously ranges between 2 and 50 μm for the first layer, and between 0.1 and 5 μm for the microstructured surface layer; that is to say, of the order of a micron. As for the first microstructured layer, the distance between two relief patterns (created by the mineral or SiC or PPSO₂ particles), ranges between 30 and 50 μm but can go up to 100 μm, which is the translation of an amplitude variation with respect to the average distance which is much greater than 10%.

Another solution is further taught by the international application WO 2010/136848 describing a method of manufacturing porous coatings with a controlled structure of microscopic or nanometric size, using an ink jet printing type method. The coating has a thickness that ranges between 10 nm and 10 mm and its porosity is created such that the distribution of the pore size is anisotropic. However, the WO 2010/136848 method is complex and costly to implement as it requires going through an intermediate step of producing a temporary layer of particles for the creation of microporosity a temporary layer that must then be eliminated. Furthermore, WO2010/136848 does not relate to a heating article, or a culinary article which typically undergo thermal stresses.

It is also possible to achieve a surface microstructuring using lithography [Langmuir, 2000, 16, 7777-7782, Ultrahydrophobic surfaces. Effects of Topography Length Scales on Wettability, D. Oner and T J McCarthy]. However, it consists in a method which indirectly structures a surface; that is to say, it uses a mask for transferring the pattern, and carries out a posterior chemical treatment to make the surface hydrophobic. The thus, silicone-made microstructured surface is coated with a surface layer of a different chemical nature (for example, siloxane or fluorocarbon resin), which has the drawback of being hardly sustainable in use. In this case, this surface layer is liable to degradation by abrasion, resulting in a reduction or even loss of the anti-stick effect. In addition, another drawback is that of a weak link between the two layers, hence, the microstructured layer can be easily removed if the coated surface is manipulated as a result of, for instance, repeated contacts while cooking food. To solve the drawbacks of the prior art, the Applicant has discovered that it was possible to structure directly (i.e. without pattern transfer, for example, through a mask) and specifies a hydrophobic coating intended to cover a heating article without any subsequent post-treatment.

For this, the Applicant has developed a method for manufacturing a heating article including a step of surface structuring using inkjet printing—a technique that involves projecting ink droplets from a small opening into positions that are well determined on a support, such as to create an image.

The ink jet printing is the only currently known printing technique that does not involve contact.

More particularly, the present invention relates to a heating article comprising:
a substrate having two opposite sides,
a heat-stable coating including:
at least a base layer including at least one heat-stable binder, said base layer being arranged on one of the sides of the substrate, and
a microstructured surface layer including a heat-stable binder of the same chemical nature as that of the base layer, said microstructured layer covering partly or entirely said base layer being sintered integrally therewith, said microstructured surface layer having a relief with patterns constituted by local variation in the surface thereof, said relief having a regularity of average pitch Ar with a SAr variation not more than 10% higher (and preferably not more than 3%) of the value of said average pitch Ar, on either side of this Ar value.

By heat-stable coating, is meant according to the present invention, a coating whereof the mechanical and physico-chemical properties do not change significantly depending on the operating temperature of the article (which may be for example 50° C. to 300° C. in the case of a culinary article).

The heat-stable binders of base and structuring layers must be of the same chemical nature or of equivalent chemical nature, capable of binding to each other by covalent, Van Der Waals or ionic bonds. It may consist of, for instance, polymeric materials of the same chemical class or with adjacent solubility parameters, or even inorganic or hybrid materials.

For example, if the heat-stable binder of the base layer is a fluorocarbon resin, that of the microstructuring layer covering the base layer is in this case also a fluorocarbon resin. Likewise, if the heat-stable binder of the base layer is a sol-gel material, it will be the same for the microstructuring layer binder.

By regular average pitch Ar of the relief or coating, for the purposes of the present invention, is meant the arithmetic average of the distance between two relief patterns on the assessment surface, as shown in FIG. 3 hereafter.

The very low value of the Variation SAr (less than 10% of the average pitch Ar) reflects a high degree of homogeneity in the positioning of the patterns, made possible by the use of an ink-jet printing technique. This homogeneity in the positioning of the patterns gives the heat-stable coating of the article according to the invention a hydrophobicity of a physical nature, which is combined with the intrinsic hydrophobicity of the chemical coating (conferred by the heat-stable binders of the base and structuring layers). The hydrophobicity of a physical nature has for effect that the water can no longer reach into the interstices of the coating surface. This means that the contact points between the water and the coating surface are reduced significantly, such that the static contact angle between the coating and the water is higher than that which would be measured with a coating surface of the same nature but which would not have been structured by ink jet printing according to the present invention.

Advantageously, the relief of the heat-stable coating of the invention has a Ra average roughness depth whose variation SAr is not more than 10% of the value of said Ra average roughness depth on both sides of this Ra value.

By Ra average roughness depth, is meant according to the present invention, the height of the pattern with respect to the lowest level of the relief, as shown in FIG. 3.

Advantageously, the average pitch Ar of the relief ranges between 5 and 75 μm, and the average roughness depth Ra of the relief ranges between 5 and 50 μm, and preferably in the range of 10 μm. These roughness parameter values correspond to a superhydrophobic surface.

It may be considered different types of articles, in accordance with the invention, having different forms and made of different materials.

Thus, the substrate may be made of a material selected from among metals, glass, ceramics and plastics.

By way of metal substrates that can be used in the method according to the invention, it may be advantageously cited aluminum substrates or aluminum alloy anodized or not, or in polished, brushed or microbeaded, sandblasted, chemically treated aluminum, or in polished, brushed or microbeaded stainless steel or cast iron or aluminum, titanium or hammered or polished copper.

The heating article according to the invention may particularly be a culinary article, particularly a culinary article whereof one of the opposite sides is an inner concave side intended to be arranged on the side where the food is liable to be introduced in said article, and a second of said opposing surfaces is an outer convex side intended to be arranged towards a heat source.

By way of non-limiting examples of culinary articles in accordance with the present invention it may particularly be cited culinary articles such as pots and frying pans, woks and sauté pans, cooking vessels and cooking pots, crepe pans, grills, pastry molds and plates, barbecue plates and grills, preparation bowls.

It can also be considered other types of substrates that are not only limited to the culinary field. Thus, it can be considered by way of heating articles according to the invention, household articles such as irons, curling irons, hair straighteners, etc., insulated containers (for coffee makers for example), kettles or mixing bowls.

According to a first embodiment of the article according to the invention, the heat-stable binder of the base layer and that of the microstructured layer each contains a fluorocarbon resin or a mixture of fluorocarbon resins, alone or mixed with other heat-stable resins.

According to a first alternative of this embodiment, the microstructured layer is in the form of fluorocarbon compounds constituting the relief of the heat-stable coating, said fluorocarbon compounds being sintered integrally with the base layer.

According to a second alternative of this embodiment, the microstructured layer further comprises microparticles each having a size ranging between 5 and 10 μm, and being composed of a material having a melting temperature that is higher by at least 20° C. than the melting temperature of the heat-stable binders of the base layer and the microstructured layer, the microparticles being regularly arranged on the base layer and covered with a continuous film of the heat-stable binder of the microstructured layer, the microparticles creating local variations in the surface level of said film which has a thickness ranging between 500 nm and 3 μm.

According to a feature of this second alternative embodiment, the microparticles advantageously have a hardness that is higher than 5 on the Mohs scale, which gives the heat-stable coating of the heating article an increased resistance to scratching.

By way of microparticles that can be used within the context of this second alternative embodiment, it may be particularly cited aluminum oxide, silica or zirconium microparticles.

According to a second embodiment of the article, the heat-stable binder of the base layer and that of the microstructured layer are each of a sol-gel material comprising at least one matrix of at least one metal polyalkoxylate.

Advantageously, the microstructured layer is covered by a finishing layer whereof the thickness is less than the roughness variation SRa of the microstructured layer.

The present invention also relates to a method for manufacturing a heating article in accordance with the invention comprising the following steps:
a) providing a substrate with two opposite sides,

then
b) producing a heat-stable coating including:
   the formation on at least one of the sides of the substrate, of at least a base layer comprising at least a heat-stable binder, and
   the formation on all or part of the base layer, of a microstructured layer partially or totally comprising a heat-stable binder of the same nature as that of the base layer, the formation of the microstructured layer comprising the ink jet printing by projection in determined positions (PI, P2, . . . , PN) of microdroplets of a dispersion in a liquid (water or organic solvent) of a structured material, said printing being achieved with a micrometric printing pitch (d), and
c) curing the heat-stable coating to sinter the binder of the base layer integrally with the binder of the microstructuring layer, so as to solidify the assembly and form a relief with patterns constituted by local variations in the surface level of the heat-stable coating. The method, according to the invention, allows for the realization of a surface microstructuring by providing a localized excess of material, this excess being made selectively and accurately by printing of inkjet printing type.

Advantageously, the printing pitch of the method according to the invention ranges between 5 μm and 75 μm, allowing to achieve a relief whereof the average pitch ranges between 5 and 75 μm.

According to a first embodiment of the method, the heat-stable binders of the base and microstructured layers comprise a fluorocarbon resin or a mixture of fluorocarbon resins, alone or mixed with other heat-stable resins. The fluorocarbon resin of the base layer may be identical or different from that of the microstructured layer.

According to a first alternative of this embodiment of the method, the structure of the heat-stable coating is achieved by using only the heat-stable binder of the microstructured layer as structuring material, this binder being present in the dispersion at a rate ranging from 2% to 20% in weight with respect to the total dispersion weight.

According to a second alternative of the first embodiment of the method, the structuring of the heat-stable coating is achieved in two steps:

1) first, is used by way of structuring material microparticles of a material having a melting temperature that is higher than the melting temperature of the heat-stable binders of the base and microstructuring layers by at least 20° C., these microparticles being dispersed in a liquid (water or organic solvent) at a rate ranging between 2% and 20% in weight with respect to the total dispersion weight,

2) and then after printing by ink jet of the microdroplets of this dispersion, is formed, after stoving, a continuous film covering the microparticles, this film comprises a heat-stable binder, which is that of the microstructured layer.

The microparticles previously deposited by inkjet printing create local variations in the surface level of said film. These microparticles are such as defined above.

Advantageously, the dispersion of the microparticles in a solvent further comprises, a film-forming agent at low temperature, whereof the content advantageously ranges between 1 and 10% in weight of the total weight of the microparticles.

By way of film-forming agents that can be used in the framework of the present invention, it can be particularly cited the cellulose derivatives (such as for example carboxymethylcellulose) or polymers (particularly methacrylics).

Advantageously, the microparticles can be treated on the surface to facilitate further spreading of the film covering the microparticles. This surface treatment may be carried out using fluorinated silanes, polymeric surfactants such as fluorinated polyoxethanes (particularly having a Mw molecular weight of 3000 g) or even with oligomers of HFPO (Hexafluoropropyloxyde) modified with silanes and/or polyethylene glycols.

According to a second embodiment of the method, the heat-stable binders of the base and microstructured layers include at least one sol-gel precursor of metallic alkoxyde type dispersed in an alcoholic medium and in water to initiate the sol-gel reaction.

In this second embodiment of the method, it is advantageously projected several microdroplets of the dispersion of structuring material, to increase the roughness depth created by stacking layers.

Preferably, the microdroplets projected in each given position are dried before the projection of another microdroplet in this position.

Other advantages and features of the present invention will become apparent from the following description given by way of non-limiting example and with reference to the accompanying figures:

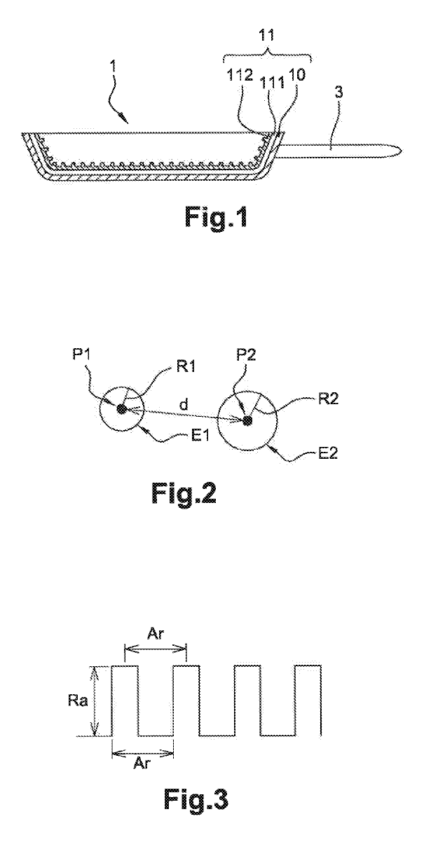

FIG. 1 represents a cross-sectional schematic view of a culinary article according to the invention,

FIG. 2 represents a block diagram illustrating the projection of microparticles in the method according to the invention,

FIG. 3 represents a block diagram of a cross-sectional view of the microstructuring layer according to the invention,

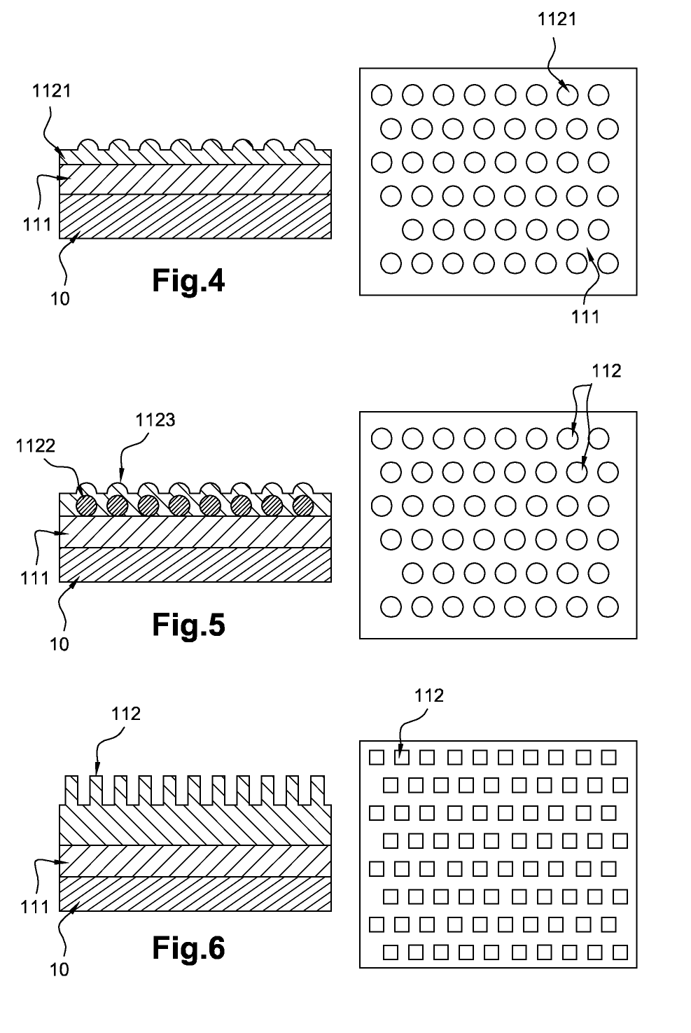

FIG. 4 represents a schematic cross-sectional view of a first example of heating article according to the invention,

FIG. 5 represents a schematic cross-sectional view of a second example of heating article according to the invention,

FIG. 6 represents a schematic cross-sectional view of a third example of heating article according to the invention.

The identical elements represented in FIGS. 1 to 6 are identified by identical numerical references.

The heating article 1 contains a substrate 10 having two opposite sides and a heat-stable coating 11.

FIG. 1 illustrates by way of example of heating article, according to the invention, a pot 1 comprising a support 10 in the form of a hollow bowl, and a grip handle 3. The inner side of the support 10 (concave) is coated with a heat-stable coating 11 according to the invention, which comprises:
at least one base layer 111 comprising at least one heat-stable binder, and
a microstructured layer 112 comprising a heat-stable binder of the same nature or of a chemical nature equivalent to that of the base layer.

Preferentially, the base layer 111 is continuous and entirely covers the side of the substrate 10 on which it is deposited.

As illustrated more specifically on FIGS. 4 to 6 and described in the corresponding examples 1 to 3, the base layer 111 may be multilayered.

The microstructuring layer 112 covers at least partially (and preferably all) the base layer 111 by being sintered integrally therewith. The base layer 111 and the microstructured layer 112 thus form an integral whole constituting the heat-stable coating 11. The microstructured layer 112 has a relief with patterns constituted by local variations in its surface level, which is characterized by the following parameters (shown on FIG. 3):
regularity, of average pitch Ar, and
depth, of average roughness Ra.

According to the invention, the relief of the heat-stable coating has a regularity of average pitch Ar with a variation SAr of not more than 10% of the value of said average pitch Ar on either side of this value. The parameter of average pitch Ar corresponds to the average distance between two first adjacent patterns. Thus, The distance between two first adjacent patterns is defined with a maximum allowed variation of 10% of its average value and variation on either side of this value, regardless of the pair of the first considered adjacent patterns of the microstructuring. Preferably, the maximum allowed variation is of 3% of the value of the distance between two first adjacent patterns.

Furthermore, the relief of the heat-stable coating (in this case the microstructured layer) preferably has an Ra average roughness depth defined with a variation SRa of not more than 10% of the value of said average roughness depth Ra on either side of this value. The roughness average Ra corresponds to the height of the patterns which extend perpendicularly to the base layer 111; that is to say, the difference in elevation between the top of the patterns and the level of the base layer 111. Thus, the height of each pattern is defined with a maximum allowed variation of 10% of the average height (with respect to this value) computed over all the patterns. Preferably, the maximum allowed variation (just as for the average pitch Ar) is only of 3% of the value of the average height calculated over the entirety of the patterns.

Typically, the value of average pitch Ar of the relief ranges between 5 μm and 75 μm, and is preferably equal to 35 μm. In this case, the maximum allowed variation on the average pitch Ar is of ±2 μm for an average pitch Ar of 20 μm and is of ±5 μm and for an average pitch Ar of 50 μm. For the preferred value of average pitch Ar of 35 μm, a variation SAr equal to ±2.5 μm is measured, which corresponds to about 7% of the value of the considered average pitch Ar (on both sides of this value).

Typically, the average roughness depth Ra of the relief ranges between 5 and 50 μm, and is preferably equal to 10 μm. Therefore, the maximum allowed variation on the average roughness depth Ra is of ±1.5 μm for an average roughness depth Ra equal to 15 μm. For the preferred value of the average roughness depth Ra equal to 10 μm, a variation SRa equal to ±0.5 μm is measured, corresponding to 5% of the value of considered average roughness depth Ra.

The method of manufacturing a heating article according to the invention such as described above comprises the following steps:
a) providing the substrate 10,
b) realizing, at least on one of the sides of the substrate 10, a heat-stable coating 11, and
c) curing the heat-stable coating 11.

The realization of the heat-stable coating 11 comprises:
the formation of, at least on one of the sides of the substrate 10, at least one base layer 111 comprising at least one heat-stable binder, and
the formation of, on the entirety or part of the base layer, a microstructured layer 112 comprising a partially or entirely heat-stable binder of the same nature as that of the base layer.

### Formation of the Base Layer

The base layer, possibly multilayered, is more particularly deposited with the conventional coating techniques of heat-stable coatings (spray, roller, curtain, screen printing).

However, it can also be deposited, like the microstructured layer, by ink jet type printing, the projected material comprising said heat-stable binder of the base layer. In this case, the pitch is adjusted to obtain a continuous layer.

### Formation of the Microstructured Layer

As is more specifically illustrated in FIG. 2, the formation of the microstructured layer 111 more particularly comprises printing by projection at determined positions P1, P2, . . . , PN of microdroplets of a dispersion in a solvent of a structuring material. The different projection positions P1, P2, . . . , PN are distributed over the surface of the substrate in a homogeneous network. The printing is performed with a micrometric printing pitch d, which advantageously ranges between 5 μm and 75 μm, and is preferably equal to 35 μm (corresponding to the preferred value of the average pitch Ar between two first adjacent patterns of the relief of the microstructured layer 112).

A commercial printer for printing designs is used. This printer typically provides a definition equal to 360 dpi (“dots per inch”), which corresponds to a printing pitch equal to 70 μm between two projection positions which are first adjacent positions. This printer comprises a plate with a plurality of nozzles for the simultaneous projection on the base layer of a microdroplet by each nozzle at each projection position of a set of positions PI, P2, . . . , PN covered by the plate. In this context, in order to achieve a printing definition of 720 dpi corresponding to a printing pitch d of 35 μm, the printing head needs to be moved by a half pitch.

As illustrated in FIG. 2, the projection of a microdroplet in a projecting position P1 causes the E1 spreading of the microdroplet projected onto the surface of the base layer. This spread has a R1 radius which not only depends on the volume of the projected microdroplet but also on the wetting of the surface of the uncured base layer by the projected microdroplet, more particularly by the solvent of the projected dispersion.

The printing pitch d and the R1 or R2 radius of each spreading E1 and E2 of one or several microdroplets in a determined P1 or P2 projection position are preferably linked by the following association:

⅓<2Ri/d<1,

where Ri corresponds to the spreading radius Ei in the projection position Pi.

Furthermore, it is also possible to use a printer with a single nozzle. In operation, the single nozzle of the plate can be moved, by a conveyor above the base layer, of the considered printing pitch or of a multiple of the considered printing pitch respectively.

It can also be considered to move the base layer by a conveyor, under the fixed nozzle of the considered printing pitch or of a multiple of the considered printing pitch respectively.

Preferably, the projection direction of each microdroplet in a projecting position is perpendicular to the local surface of the base layer in this position, by tilting the substrate, and/or the nozzle and/or nozzle plate.

### Heat-Curing

The curing of the heat-stable coating allows for the sintering of the heat-stable binder of the base layer 111 integrally with the heat-stable binder of the microstructured layer 112, which leads to solidifying the assembly and forming a relief with patterns constituted by local variations in the heat-stable coating 11 surface.

The invention is further illustrated in the following examples.

In these examples, unless otherwise indicated, all percentages and parts are expressed in weight.

### PRODUCTS AND DEVICES

### Structuring Material

PTFE powders: TF 9207 PTFE of Dyneon or powder FLUO HT-LS Micro Powders, whereof the particles have a size ranging between 5 μm and 10 μm to avoid clogging the nozzles of the printer (example 1),

aluminum oxide, zirconia or silica powders (example 2)

sol-gel precursor of a mixture of methyltriethoxysilane (MTES) and tetraethoxysilane (TEOS) (example 3),

pigments whereof the particle size is less than 5 mm (example 3),

### Substrates

aluminum disks of 31 cm in diameter and 2.4 mm in thickness.

### Printing Device

commercial printer with nozzles of suitable size.

### EXAMPLES

### Example 1

### A Culinary Article with a Heat-Stable Coating Layer Comprising a Fluorocarbon Resin Microstructured Layer

It is applied on an aluminum substrate (pretreated for improved adhesion) a PTFE-based multi-layer coating whereon is applied by ink jet a dispersion powder of PTFE in a polar solvent or an aqueous medium at a rate of 2% to 20% in weight with respect to the total weight of the dispersion.

The solvent can be of two different types.

According to a first alternative, the solvent is more particularly polar, particularly selected from among esters, ethers or ketones. In this case, the solution can further advantageously comprise a fluorinated type surfactant to facilitate the stability of the PTFE powder suspension.

According to a second alternative, the solution may be prepared in aqueous medium, and necessarily in the presence of a fluorinated type surfactant.

Whatever the nature of the medium (aqueous or polar solvent), the surfactant content advantageously ranges between 0.05% and 5% of the weight of the powder.

By way of fluorinated surfactants that can be used in the PTFE dispersions, it can be particularly cited the fluorinated polyoxethanes (with Mw of the order of 3000 g) or oligomers of HFPO (hexafluoropropyloxyde) modified with amines or polyethylene glycols.

After the formation of the microstructured layer by ink jet printing, the heat-stable coating is subjected to curing at 400-450° C. for 10 minutes, during which the solvent and, if possible, the surfactant are evaporated, whereas the PTFE powder microparticles are sintered integrally with the base layer and form bumps 1121, which thus constitute the patterns of the heat-stable coating relief 11. When several PTFE microparticles are projected in one same projecting position, they are then sintered not only with the base layer, but also together.

Measuring the contact angle between a water drop and the surface of the coating has a value ranging between 140° and 160° at ambient temperature and a value of about 100° at hot temperature, i.e. at food-cooking temperature, namely around 200° C.

The thus obtained heat-stable coating is illustrated in FIG. 4.

### Example 2

### A Culinary Article with a Heat-Stable Coating Comprising Metallic Oxide Microparticles Covered with a Continuous Fluorocarbon-Resin Film

The base layer 111 is carried out similarly to example 2 on an equally identical aluminum substrate.

However, the structuring material is here constituted by alumina, silica and even zirconia microparticles 1122. These microparticles 1122 are dispersed in water or in a polar solvent at a rate ranging between 2% to 20% in weight with respect to the total weight of the dispersion, with or without surfactant.

By way of polar solvent and surfactant the same ones can be used as in example 1.

Furthermore, the solution can also advantageously contain a low-temperature film-forming agent allowing for a temporary fixing of each spreading E1, E2, . . . , EN of one or several microdroplets of the dispersion on the base layer. This film-forming agent is preferably a cellulose derivative such as carboxymethylcellulose or a methacrylic polymer. The film-forming agent content ranges between 1 and 10% in weight of microparticles 1122.

The printing of the microdroplets of the dispersion is followed by the formation of a continuous film 1123 covering the microparticles, this film 1123 comprising a heat-stable binder, which is also PTFE based and at the surface of which the microparticles 1122 create local variations in the surface level. The film 1123 is deposited using the techniques of conventional coating of heat-stable coatings (spray, roller, curtain, screen printing).

Advantageously, prior to the formation of the film 1123, the microparticles powder 1122 is treated in order to facilitate the subsequent spreading of the protective film 1123. Treatments based on fluorinated silanes, fluorinated polyoxethanes (with Mw of the order of 3000 g) or of HFPO oligomers (hexafluoropropyloxyde) modified with silanes and/or polyethylene glycols are particularly effective.

After the formation of the microstructured layer, the assembly is cured at 400-450° C. during 10 minutes. Whereas the solvent and, where appropriate, the surfactant present in the solution become evaporated during curing, the PTFE film 1123 covering the microparticles 1122 sintered integrally with the base layer 111.

Measuring the contact angle between a water drop and the surface of the coating has a value ranging between 140° and 160° in ambient temperature and a value of about 100° in hot temperature, i.e. at food-cooking temperature, namely at approximately 200° C.

The thus, obtained heat-stable coating 11 is illustrated in FIG. 5.

### Example 3

### A Culinary Article with a Heat-Stable Coating Comprising a Microstructured Polyalkoxylate Layer

The heat-stable coating of example 3 differs from that of example 1 by the nature of the heat-stable binders of the base and microstructured layers of metallic polyalcoxylate type.

A sol-gel coating of metallic polyalkoxylate type (constituting the base layer 111) is applied on an aluminum substrate that has already been treated (to ensure maximum adherence of this coating).

It is then applied MTES and TEOS dispersion by ink jet printing in an alcoholic medium, further comprising:
water to allow the initiation of a hydrolysis-condensation reaction,
an organic acid such as acetic acid to catalyze and stabilize the hydrolysis-condensation reaction,
a colloidal silica dispersion, and
pigments whereof the size does not exceed 5 μm (to avoid clogging the printer nozzles).

If the height of the patterns need to be high, one must apply several layers of this dispersion.

The assembly is cured at 250° C.-300° C. during fifteen minutes.

Thus, a ceramic coating with a controlled micrometric roughness is obtained. A static contact angle θ ranging between 120° and 150° at ambient temperature and a static contact angle θ higher than 100° at a temperature of 200° C. is measured.

1. A heating article comprising:
a substrate having two opposite sides,
a heat-stable coating comprising:
at least a base layer comprising at least one heat-stable binder, said base layer being arranged on one of the sides of the substrate, and
a microstructured surface layer comprising a heat-stable binder of the same chemical nature as that of the base layer, said microstructured layer partially or completely covering said base layer and being sintered integrally with the latter,
said microstructured surface layer having a relief with patterns constituted by local variations in its surface level, said relief having a regularity in average pitch Ar with a variation SAr not more than 10% of the value said average pitch Ar, on either side of this value Ar.

2. The heating article, according to claim 1, wherein said relief exhibits an average surface roughness Ra with a variation SAr of at most 10% of the value of said average depth roughness Ra on both sides of this value Ra.

3. The heating article, according to claim 1, wherein the average pitch Ar of the relief ranges between 5 μm and 75 μm.

4. The heating article, according to claim 2, wherein the average depth roughness Ra of the relief ranges between 5 μm and 50 μm.

5. The heating article, according to claim 1, wherein the heat-stable binder of the base layer and that of the microstructured layer comprise a fluorocarbon resin or a mixture of fluorocarbon resins either alone or mixed with other heat-stable resins.

6. The heating article, according to claim 1, wherein the heat-stable binder of the base layer and that of the microstructured layer are made of a sol-gel material comprising at least one matrix of at least a metallic polyalkoxylate.

7. The heating article, according to claim 5, wherein the microstructured layer is in the form of fluorocarbon compounds forming the relief of the heat-stable coating, said fluorocarbon compounds being sintered integrally with the base layer.

8. The heating article, according to claim 5, wherein the microstructured layer further comprises microparticles each having a size ranging between 5 μm and 10 μm and made of a material having a melting temperature exceeding by at least 20° C. the melting temperature of the heat-stable binders of the base layer and the microstructured layer, said microparticles being regularly arranged on the base layer and being covered by a continuous film of said heat-stable binder of the microstructured layer, said microparticles creating local variations in the surface level of said film.

9. The heating article, according to claim 8, wherein the microparticles have a hardness that is higher than 5 on the Mohs scale.

10. The heating article, according to claim 8, wherein the microparticles are one of aluminum oxide, silica or zirconium particles.

11. The heating article, according to claim 1, wherein the microstructured layer is covered by a finishing layer having a thickness less than the variation SRa of the roughness of the microstructured layer.

12. A method of manufacturing a heating article comprising the following steps:
a) providing a substrate comprising two opposite sides, then
b) producing a heat-stable coating comprising:
formation of, on at least one of the sides of the substrate, at least a base layer comprising at least one heat-stable binder, and formation of, on all or part of the base layer), a microstructured layer partially or totally comprising a heat-stable binder of the same nature as that of the base layer, the formation of the microstructured layer comprising inkjet printing by projection at determined positions (PI, P2, . . . , PN) of microdroplets of a dispersion in a solvent of a structuring material, said printing being achieved with a micrometric printing pitch (d), and
c) curing the heat-stable coating to sinter the binder of the base layer integrally with the binder of the microstructured layer, such as to solidify the assembly and form a relief with patterns formed by local variations in the surface level of the heat-stable coating.

13. The method according to claim 12, wherein the printing pitch (d) ranges between 5 and 75 μm.

14. The method according to claim 12, wherein the heat-stable binders of the base and microstructured layers comprise a fluorocarbon resin or a mixture of fluorocarbon resins, alone or as a mixture with other heat-stable resins.

15. The method according to claim 14, wherein the structuring material consists entirely of the heat-stable binder of the microstructured layer, the heat-stable binder being present in the dispersion in an amount ranging between 2% to 20% in weight with respect to the total weight of the dispersion.

16. The method according to claim 14, wherein the structuring material comprises microparticles of a material that has a melting temperature that is higher by at least 20° C. to the melting temperature of the heat-stable binders of the base and microstructured layers, dispersed in the solvent in an amount of 2% to 20% in weight with respect to the total weight of the dispersion, and in that the printing of the microdroplets of the dispersion is followed by the formation of a continuous film covering said microparticles, said film comprising the heat-stable binder of the microstructured layer and said microparticles creating local variations of the surface level of said film.

17. The method according to claim 16, wherein the microparticles have a hardness that is higher than 5 on the Mohs scale.

18. The method according to claim 16, wherein the microparticles are one of aluminum oxide, silica or zirconia.

19. The method according to claim 12, wherein the heat-stable binders of the base and the microstructured layers comprise water and at least one sol-gel precursor of metallic alkoxyde type dispersed in an alcoholic medium.

20. The method according to claim 19, wherein the method comprises a drying of the microdroplet or microdroplets projected in each position before the projection of another microdroplet in said position.
